(19) United States
(12) Patent Application Publication
(10) Pub. No.: US 2018/0116300 A1
(43) Pub. Date: May 3, 2018

(54) PULLOVER GARMENT WITH INTEGRATED MEDIA ACCESSORIES

(71) Applicant: Johnny Fleming, Keiser, AR (US)

(72) Inventor: Johnny Fleming, Keiser, AR (US)

(21) Appl. No.: 15/340,411

(22) Filed: Nov. 1, 2016

(51) Int. Cl. A41D 1/00; A41D 27/20; A41D 3/00; A41D 1/04; A41B 1/08

(52) U.S. Cl. CPC A41D 1/005; A41D 27/205; A41D 3/00; H04R 1/1016; A41B 1/08; A41D 2200/20; A41D 1/04

(57) ABSTRACT

A pullover garment that includes: a clear front pocket adapted to receive a portable electronic device; thumb holes within the clear front pocket; a hood; and earbuds extending from the hood, where the earbuds are adapted to connect to the portable electronic device. The portable electronic device preferably includes a smartphone.

### BACKGROUND OF THE INVENTION

### Field of Invention

The present invention relates to a pullover garment with integrated media accessories.

### Description of Related Art

Pullover garments are a form of dress that may or may not include a hood feature for head covering. Pullover garment may be in form of a jacket, sweatshirt or casual shirt. Most pullover garments may be use for functional aspects in terms of exercise and fitness or simply for stylish aspects. Many pullover garments are used in colder weather environment. This aspect is especially true with the pullover garment that includes a hood attachment.

Interactivity with smartphones is a highly prevalent in the modern society. Many people use smartphones daily for various activities and interaction. Further headphones are used quite often with smartphones for listening to music, talking on the phone or just simply streaming audio data. As a result, it would be advantageous to have a pullover garment, which included accessories that could be incorporated with a smartphone to increase convenience and use for the user.

### SUMMARY OF THE INVENTION

The present invention relates to a pullover garment that includes: a clear front pocket adapted to receive a portable electronic device; thumb holes within the clear front pocket; a hood; and earbuds extending from the hood, where the earbuds are adapted to connect to the portable electronic device. The portable electronic device preferably includes a smartphone.

### BRIEF DESCRIPTION OF DRAWINGS

FIG. 1 depicts a pullover garment in accordance with the present invention.

### DETAILED DESCRIPTION

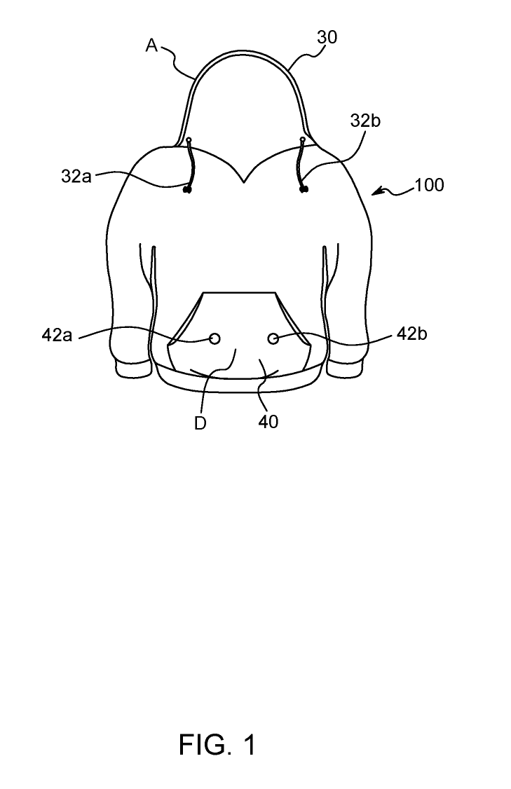

The present invention relates to a pullover garment that includes media interactive accessories. In particularly, the present invention is a pullover garment that includes a front pocket designed to secure a smartphone. The pocket includes two thumbholes that allow a user to engage with the smartphone within the pocket. An additional feature of the pullover garment includes a pair of earbuds extending from the hood attachment of the garment. An earbud is provided on each side so it may be connected to the Smartphone within the front two-layer pocket of the pullover garment. Preferably, the pullover garment is a long-sleeve garment however it could possibly be presented in a short-sleeve version. In reference to FIG. 1, the Pullover Garment 100 in accordance with the present invention is depicted. The Pullover Garment 100 includes a Hood Attachment 30 with a front clear Pocket 40. The front clear Pocket 40 includes thumbholes in a 42a, 42b. Another feature of this Pullover Garment 103 includes Earbuds 32a, 32b which extend from Hood 30. Each earbud may be connected into a smartphone that is placed within the front Pocket 40. The Pullover Garment 100 therefore provides a mechanism to protect a smartphone and thumbholes to allow interaction with the phone without removing the phone from the user's pocket. Although again shown as the long-sleeve pullover, this pullover may be easily converted to a short-sleeve with the pocket and earbud features. The instant invention has been shown and described in what it considers to be the most practical and preferred embodiments. It is recognized, however, that departures may be made there from within the scope of the invention and that obvious modifications will occur to a person skilled in the art.

What is claimed is:

1. A pullover garment comprising:
a. a clear front pocket adapted to receive a portable electronic device;
b. thumb holes within the clear front pocket;
c. a hood; and
d. earbuds extending from the hood, where the earbuds are adapted to connect to the portable electronic device.

2. The pullover garment according to claim 1, wherein the portable electronic device includes a smartphone.
